(19) United States
(12) Patent Application Publication
(10) Pub. No.: US 2010/0085304 A1
(43) Pub. Date: Apr. 8, 2010

(54) MODIFYING THE APPEARANCE OF A MOVABLE POSITION-MARKER ON A DISPLAY SCREEN OF A HANDHELD ELECTRONIC COMMUNICATION DEVICE

(75) Inventors: Andrew Robert Patterson, Waterloo (CA); Matthew Bells, Waterloo (CA); Tareq Ismail, Ottawa (CA)

Correspondence Address: RIM, 1000 LOUISIANA STREET, FIFTY-THIRD FLOOR, HOUSTON, TX, 77002, US

(73) Assignee: RESEARCH IN MOTION LIMITED, Waterloo (CA)

(21) Appl. No.: 12/575,822

(22) Filed: Oct. 8, 2009

Related U.S. Application Data
(60) Provisional application No. 61/103,925, filed on Oct. 8, 2008.
(60) Provisional application No. 61/103,927, filed on Oct. 8, 2008.

(51) Int. Cl. G09G 5/08; G06F 3/048

(52) U.S. Cl. 345/157; 715/822

(57) ABSTRACT

Modifying the appearance of a movable position-marker on a display screen of an electronic device is disclosed. A graphical user interface program is run on a microprocessor module of the electronic device that controls display of images on a display screen. Designating a partial area of a page of displayed using an overlaid position marker which has a perimeter defining a highlighting area. The bounded area can be partially non-uniformly filled.

### CROSS REFERENCE TO RELATED APPLICATIONS

The present application claims priority benefit to U.S. provisional application 61/103,925, filed Oct. 8, 2008, and U.S. patent application Ser. No. 61/103,927, filed Oct. 8, 2008, which applications are each expressly incorporated by reference herein.

### TECHNICAL FIELD

This disclosure is directed toward a communication device that includes a graphical user interface that has a display screen having a movable position-marker that is an area bounded by a perimeter that is filled by a color or image.

### BRIEF DESCRIPTION OF THE DRAWINGS

FIG. 1 depicts a communication device having a graphical user interface with a position-marker highlighting textual data;

FIG. 2 is a block diagram representing a communication device interacting in a communication network;

FIG. 3 depicts a menu of a communication device with a graphical user interface with a position-marker highlighting textual data;

FIG. 4 depicts an alternate embodiment of a graphical user interface with a position-marker highlighting textual data;

FIG. 5 depicts an alternate embodiment of a graphical user interface with a position-marker highlighting textual data in color gradient format;

FIG. 6 depicts an alternate embodiment of a graphical user interface with a position-marker highlighting textual data with an image;

FIG. 7 is a flow chart representation of an exemplary method contained within the disclosure; and

FIG. 8 is a tree-diagram representation of a definition of a class.

### DETAILED DESCRIPTION

It will be appreciated that for simplicity and clarity of illustration, where considered appropriate, reference numerals can be repeated among the figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, well-known methods, procedures and components have not been described in detail so as not to obscure the embodiments described herein. Also, the description is not to be considered as limiting the scope of the embodiments described herein.

The embodiments described herein generally relate to a display portion of a graphical user interface 110 within electronic devices 300. Examples of electronic devices 300 include pagers, cellular phones, smart-phones, mobile devices, wireless organizers, personal digital assistants, media players, gaming devices, navigation devices, sports training devices, notebook computers and other electronic devices having a graphical user interface.

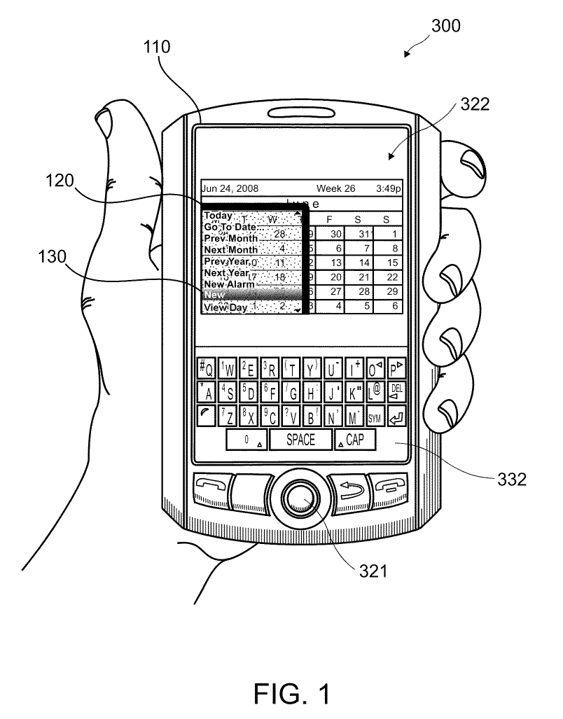

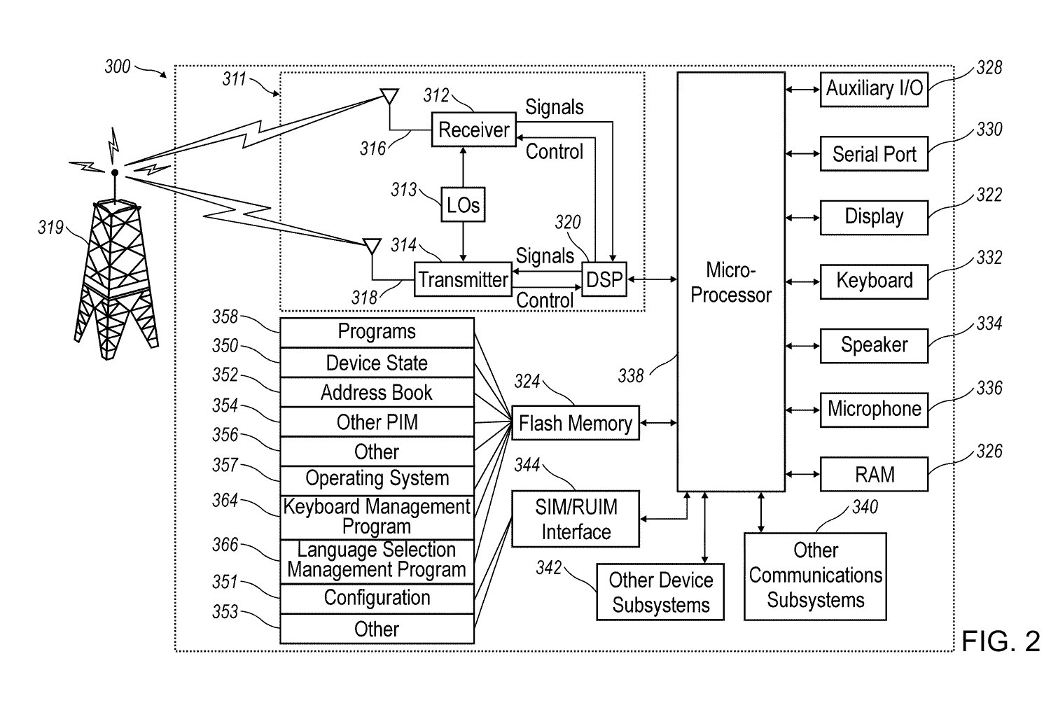

An exemplary electronic device 300 is shown in FIG. 1, and the device's 300 cooperation in a wireless network 319 is exemplified in the block diagram of FIG. 2. These figures are exemplary only, and those persons skilled in the art will appreciate the additional elements and modifications necessary to make the electronic device 300 work in particular network environments. While in the illustrated embodiment, the electronic device 300 comprises a handheld communication device, in other embodiments, the electronic device 300 can comprise a handheld wireless communication device, a personal digital assistant (PDA), laptop computer, desktop computer, a server, or other communication device.

As shown in the block diagram of FIG. 2, the electronic device 300 includes a microprocessor 338 that controls the operation of the electronic device 300. A communication subsystem 311 performs communication transmission and reception with the wireless network 319. The microprocessor 338 further can be connected with an auxiliary input/output (I/O) subsystem 328 which can be connected to the device. Additionally, in at least one embodiment, the microprocessor 338 can be connected to a serial port (for example, a Universal Serial Bus port) 330 which can allow for communication with other devices or systems via the serial port 300. A display 322 can be connected to microprocessor 338 to allow for displaying of information to an operator of the device. When the electronic device 300 is equipped with a keyboard 332, the keyboard can also be connected with the microprocessor 338. The electronic device 300 can include a speaker 334, a microphone 336, random access memory (RAM), and flash memory 324, all of which can be connected to the microprocessor. Additionally, a vibrator 132, which can be a vibrator motor, can be connected with the microprocessor 338 to generate vibrations in the electronic device 300. Other similar components can be provided on the device as well and optionally connected to the microprocessor 338. Other communication subsystems 340 and other communication device subsystems 342 are generally indicated as being functionally connected with the microprocessor 338 as well. An example of a communication subsystem 340 is that of a short range communication system such as BLUETOOTH® communication module or a WI-FI® communication module (a communication module in compliance with IEEE 802.11b) and associated circuits and components. Additionally, the microprocessor 338 is able to perform operating system functions and enables execution of programs on the electronic device 300. In some embodiments not all of the above components are included in the electronic device 300. For example, in at least one embodiment the keyboard 332 is not provided as a separate component and is instead integrated with a touch-sensitive display (not shown).

The auxiliary I/O subsystem 328 can take the form of a variety of different navigation tools (multi-directional or single-directional) such as a trackball navigation tool 321 as illustrated in the exemplary embodiment shown in FIG. 1, or a thumbwheel, a navigation pad, a joystick, touch-sensitive interface, or other I/O interface. These navigation tools can be located on the front surface of the electronic device 300 or can be located on any exterior surface of the electronic device 300. Other auxiliary I/O subsystems can include external display devices and externally connected keyboards (not shown). While the above examples have been provided in relation to the auxiliary I/O subsystem 328, other subsystems capable of providing input or receiving output from the electronic device 300 are considered within the scope of this disclosure. Additionally, other keys can be placed along the side of the electronic device 300 to function as escape keys, volume control keys, scrolling keys, power switches, or user programmable keys, and can likewise be programmed accordingly.

Furthermore, the electronic device 300 is equipped with components to enable operation of various programs, as shown in FIG. 2. In an exemplary embodiment, the flash memory 324 is enabled to provide a storage location for the operating system 357, device programs 358, and data. The operating system 357 is generally configured to manage other programs 358 that are also stored in memory 324 and executable on the processor 338. The operating system 357 honors requests for services made by programs 358 through predefined program 358 interfaces. More specifically, the operating system 357 typically determines the order in which multiple programs 358 are executed on the processor 338 and the execution time allotted for each program 358, manages the sharing of memory 324 among multiple programs 358, handles input and output to and from other device subsystems 342, and so on. In addition, operators can typically interact directly with the operating system 357 through a user interface usually including the keyboard 332 and display screen 322. While in an exemplary embodiment the operating system 357 is stored in flash memory 324, the operating system 357 in other embodiments is stored in read-only memory (ROM) or similar storage element (not shown). As those skilled in the art will appreciate, the operating system 357, device program 358 or parts thereof can be loaded in RAM 326 or other volatile memory.

In one exemplary embodiment, the flash memory 324 contains programs 358 for execution on the electronic device 300 including an address book 352, a personal information manager (PIM) 354, and the device state 350. Furthermore, programs 358 and other information 356 including data can be segregated upon storage in the flash memory 324 of the electronic device 300.

When the electronic device 300 is enabled for two-way communication within the wireless communication network 319, it can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the electronic device 300 can require a unique identifier to enable the electronic device 300 to transmit and receive signals from the communication network 319. Other systems may not require such identifying information. GPRS, UMTS, and EDGE use a Subscriber Identity Module (SIM) in order to allow communication with the communication network 319. Likewise, most CDMA systems use a Removable User Identity Module (RUIM) in order to communicate with the CDMA network. The RUIM and SIM card can be used in multiple different electronic devices 300. The electronic device 300 can operate some features without a SIM/RUIM card, but it will not be able to communicate with the network 319. A SIM/RUIM interface 344 located within the electronic device 300 allows for removal or insertion of a SIM/RUIM card (not shown). The SIM/RUIM card features memory and holds key configurations 351, and other information 353 such as identification and subscriber related information. With a properly enabled electronic device 300, two-way communication between the electronic device 300 and communication network 319 is possible.

If the electronic device 300 is enabled as described above or the communication network 319 does not require such enablement, the two-way communication enabled electronic device 300 is able to both transmit and receive information from the communication network 319. The transfer of communication can be from the electronic device 300 or to the electronic device 300. In order to communicate with the communication network 319, the electronic device 300 in the presently described exemplary embodiment is equipped with an integral or internal antenna 318 for transmitting signals to the communication network 319. Likewise the electronic device 300 in the presently described exemplary embodiment is equipped with another antenna 316 for receiving communication from the communication network 319. These antennae (316, 318) in another exemplary embodiment are combined into a single antenna (not shown). As one skilled in the art would appreciate, the antenna or antennae (316, 318) in another embodiment are externally mounted on the electronic device 300.

When equipped for two-way communication, the electronic device 300 features a communication subsystem 311. As is understood in the art, this communication subsystem 311 is modified so that it can support the operational needs of the electronic device 300. The subsystem 311 includes a transmitter 314 and receiver 312 including the associated antenna or antennae 316, 318) as described above, local oscillators (LOs) 313, and a processing module 320 which in the presently described exemplary embodiment is a digital signal processor (DSP) 320.

It is contemplated that communication by the electronic device 300 with the wireless network 319 can be any type of communication that both the wireless network 319 and electronic device 300 are enabled to transmit, receive and process. In general, these can be classified as voice and data. Voice communication generally refers to communication in which signals for audible sounds are transmitted by the electronic device 300 through the communication network 319. Data generally refers to all other types of communication that the electronic device 300 is capable of performing within the constraints of the wireless network 319.

Example device programs that can depend on such data include email, contacts and calendars. For each such program synchronization with home-based versions of the programs can be desirable for either or both of their long term and short term utility. As an example, emails are often time sensitive, so substantially real time synchronization can be desired. Contacts, on the other hand, can be usually updated less frequently without inconvenience. Therefore, the utility of the electronic device 300 is enhanced when connectable within a communication system, and when connectable on a wireless basis in a network 319 in which voice, text messaging, and other data transfer are accommodated.

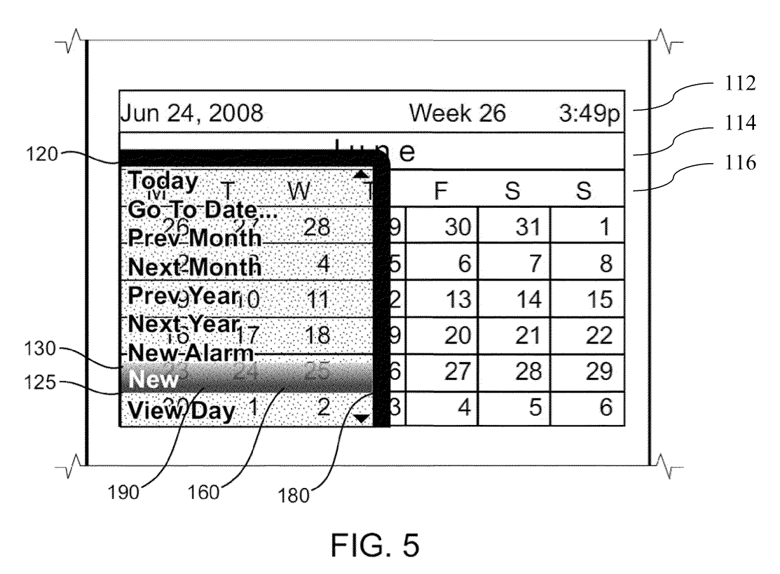

An example of an electronic device having a graphical user interface 110 on a display screen 322 is illustrated in FIG. 1, with an enlarged view of a display screen shown in FIG. 5. The display screen 322 can be a traditional display screen which only displays graphical data to a user or it can be an interactive display screen which allows a user to input data via the display screen 322. Examples of interactive display screens include capacitive displays, surface acoustic wave tactile displays, resistive displays and the like. A calendar program running on the microprocessor of the electronic device 300 displays a month view of the calendar. The month view of the calendar in the example contains nine rows. The top row 112 of the month view contains lettering showing the date, the number of the week and the time. The top row 112 is of a uniform color, except for the lettering, with lettering being defined by the absence of that color. The second row 114 of the month view is a uniform color, except for lettering shown by the absence of that color. The lettering in the second row indicates the month, which in this example is “June.” The color of the second row 114 is different from the top row 112 such as to make it visually distinct from the top row 112. The third row 116 is a uniform color, which can be the same color as the top row 112. The third row 116 of the month view shows contains letters “M,” “T,” “W,” “Th,” “F,” “S,” and “S” marking columns corresponding to days of the week. The third row 116 is of a color making it visually distinct from its adjacent rows. The remaining rows contain numbered days as in a standard calendar.

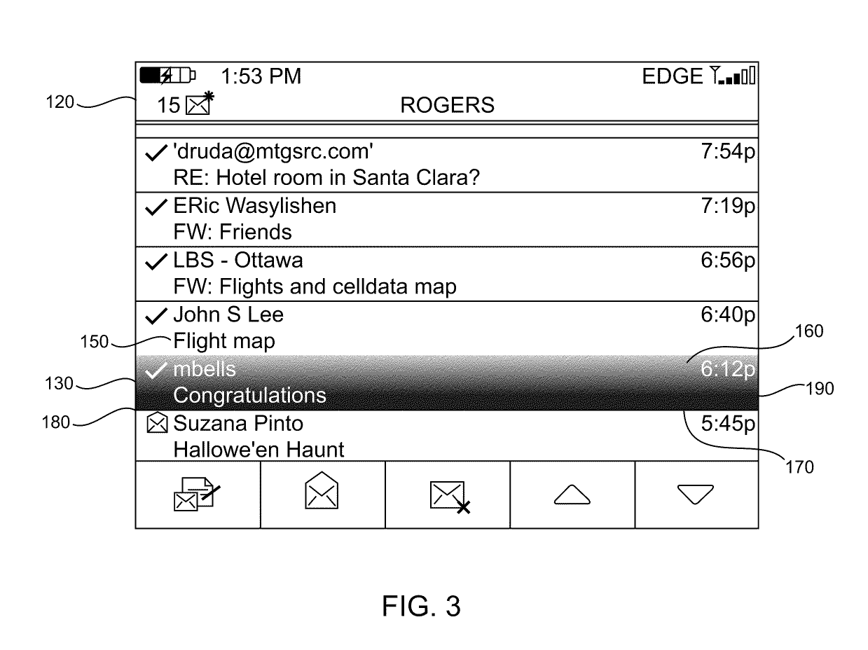

A user may wish to change the view or input an entry into the calendar through a menu 120 as shown on the display screen 322. In order to navigate the menu 120 a movable position-marker 130 can be used. The movable position-marker 130 is illustrated in FIG. 1 as a bar for signifying which menu item 125 the user has navigated over. Another illustration of the movable position-marker 130 is presented in FIGS. 3, 5 and 6.

The menu 120 in FIG. 1 has opaque regions and translucent regions. Opaque within this disclosure means a portion of the underlying image on the display screen is not seen through the cursor or position marker. The month view on the display screen 322 is partially visible through the translucent regions of the menu 120. The menu 120 is bounded by a solid opaque color, which in the example shown is black. However the color can be any color which makes it visually distinct from the translucent portion of the menu and the month view. Except for the movable position-marker 130 within the menu 120, the translucent regions of the menu 120 shown are a light brown; however any coloration that allows the display screen 322 to be visible therethrough may be used. Additionally, in the example shown the coloration in the translucent portions of the menu 120 are not uniformly shaded, but instead have variations in darkness. The coloring of the lettering or textual data within the menu 120 is such as to make it visually distinct from both the surrounding regions of the menu 120 and the month view. The movable position-marker 130 in this example is a non-uniform blue, with lettering shown in white. In the example shown, the color of the movable position-marker 130 is on a gradient—from a dark blue at the bottom to a lighter blue at the top. However, those skilled in the art will recognize that the movable position marker 130 can be any coloration that makes marker 130 distinct. Thus the color scheme of the display screen allows a user to view a menu 120 of choices without the primary view on the display screen (in this example a month view) being totally obscured.

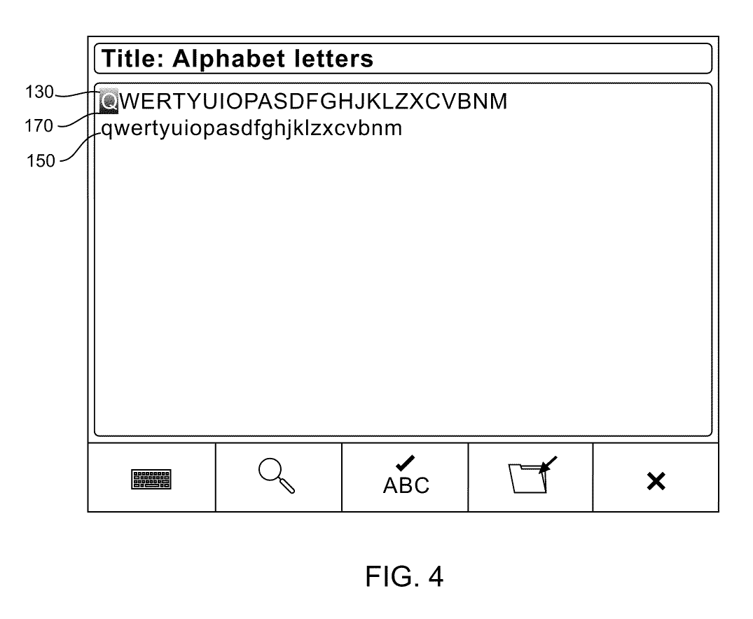

In addition to the examples described above, the movable position-marker 130 can be sized such that it is only the size of a single text character 150, as shown in FIG. 4. This size of the movable position-marker 130 can be known as a caret. The caret can be used to select a particular text character 150 from a plurality of characters. For example, the movable position-marker can allow a user to input additional text 150 into a particular position. Additionally, the movable position-marker 130 can be a cursor, the location of which is user controllable.

The movable position-marker 130 allows the user to understand which item 125 has been selected for further action. Thus, it is desirable to have the movable position-marker 130 signified distinctly from other images 140 or text 150 displayed on the screen 322. For example, FIG. 3 illustrates an email listing displayed on the display screen 322. In a listing such as the email listing, the movable position-marker 130 signifies the email for further action, such as opening, forwarding, and replying. In order to invoke the additional action, the device can require an additional signal indicative of the action such as a click of the trackball, a tap on the touch sensitive screen 322, or a more forceful actuation of the touch screen 322.

The menu 120 of FIG. 3, which contains an email listing, has a black boundary with icons and lettering therein shown in white, yellow, green and red. The boundary can be any color that makes it distinct from the interior of menu 120. Except for the movable position-marker, the items listed within the email listing are shown in white bounded by lines, with lettering and other data (which in this example includes receipt times of the email messages) shown in black and gray. The movable position-marker is shown in a blue gradient 190 similar to the movable position-marker of FIG. 1. The color scheme described is exemplary only and any coloration that makes the items, markings and indicia visually distinguishable is within this disclosure.

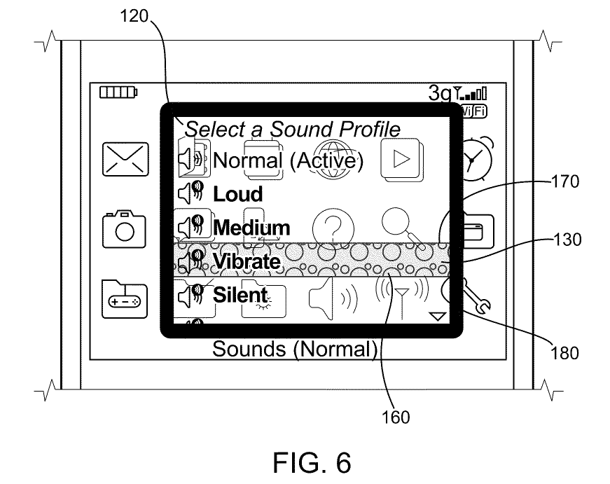

As illustrated, in at least FIGS. 3 and 6, the movable position-marker 130 has a perimeter 170 and the area 160 defined by the perimeter 170 of the movable position-marker 130 is filled with an image. In at least one embodiment, the perimeter 170 of the movable position-marker 130 is defined as a polygon. The image used to fill the perimeter 170 of the movable position-marker 130 can be based upon defining colors at a plurality of vertices 180 of the polygonal perimeter 170 of the movable position-marker 130. With the colors defined at the vertices 180 a filling routine can be implemented to generate a gradient 190 across the area 160 defined by the vertices 180. For example in FIG. 3, the vertices 180 of the rectangle defining the perimeter 170 of the movable position-marker 130 have two top corners that are colored light blue and two bottom corners that are colored dark blue. The area 160 defined by the perimeter 170 can be filled using a linear interpolation as illustrated. In other embodiments, the interpolation can be performed using other interpolation routines such as exponential and log for example. While a specific example has been given in relation to colors and vertices, 180 it should be appreciated that the disclosure is not limited to these arrangements. For example more than four vertices 180 can be required to define a particular polygon. Additionally, each vertex can have a different color.

In the example illustrated in FIG. 4, the movable position-marker 130 is sized for selection of a single character of text 150 in a text editing program. As described above, the movable position-marker 130 as illustrated in FIG. 4 can also be called a caret. The caret in this example is a light blue, with the character within the caret indicated by an absence of color, whereas the remainder of the textual data 150 in this example is black. The movable position-marker as illustrated in FIG. 4 also has a gradient (not labeled for clarity) of color that fills the area with the perimeter 170 of the polygon defining the movable position-marker 130. This color differentiation from the remainder of the text editing program allows for the moveable position-marker to be distinguished therefrom. The gradient of color associated with the caret allows a user to distinguish the highlighted portion associated with the movable position-marker 130. For example, in bright sunlight, the gradient can allow a user to distinguish the area highlighted by the movable position-market 130. Additionally, in some instances the background color associated with the page of information can have a color that would otherwise make it difficult to see a color that is not highly contrasted; by incorporating the gradient, the movable position-marker becomes more easily distinguishable. Additionally, if the page of information has text displayed thereon and the overlaid position marker 130 is positioned over the text, the gradient can provide a better contrast with a wider selection of colors of the text than a single color, thereby enhancing readability in accordance with certain embodiments. This control of the caret can be utilized in handheld devices which are susceptible to changing environments in contrast to typical desktop computers and the like which experience more uniform operating conditions, including but not limited to light conditions and viewing angle.

Another illustrative example of the movable position-marker 130 is provided in FIG. 6. FIG. 6 shows a possible view of a display screen within this disclosure. The outer region of the display screen is solid dark grey. Framed within said outer region and colored in black is an inner region containing numerous user-selectable icons. The icons are a light gray, different from the gray of the outer region, however any coloration that makes them visible is within this disclosure. In this example an icon corresponding to sound profile settings has been selected by the user, and as a result a menu 120 is visible on top of the inner region of the display. However, because the bounded region of the menu 120 is translucent like the menu in FIG. 1, the icons are at least partially visible through the menu 120. The menu 120 is shown in a bluish hue with the lettering of the menu shown in white. The icons which are seen through the menu are visible as a lighter bluish color. The movable position-marker 130 has a graphical image displayed within its perimeter 170. In the present example, the image is that of dots on a background. The image file can comprise one of a bitmap, a portable network graph, a jpeg, or a graphics interchange format, among other files. While not illustrated, the dots can have a different color from the background within the perimeter 170 of the movable position-marker 130. As illustrated the image is also semi-transparent allowing the background of both the underlying menu 120 and the home screen to be seen through the movable position-marker 130.

In at least one embodiment, the overlaid position-marker 130 as described herein can be adjusted using data obtained from a layout manager for optionally controlling the display of template information. In one embodiment, the layout manager supplies data that is used by the one or more programs running on the device capable of displaying images and other graphical items to the user. The template information can be stored in a data store which can be on RAM, ROM, and Flash memory or the like. The template information can be input into the data store by the manufacturer. In another embodiment, the template information can be downloaded from a remote database if the electronic device is wirelessly enabled. Other techniques of obtaining template information can be used as well, such as device programming and the like. In at least one embodiment, the substantial entirety of the highlighting area is filled using an image obtained from the layout manager that is associated with the template. In another embodiment, the image can be an image that is modified based upon the template information. The template information can also include theme information, which coordinates a variety of different images and items displayed on the graphical user interface. This display of information according to a theme enables coordination of the displayed images.

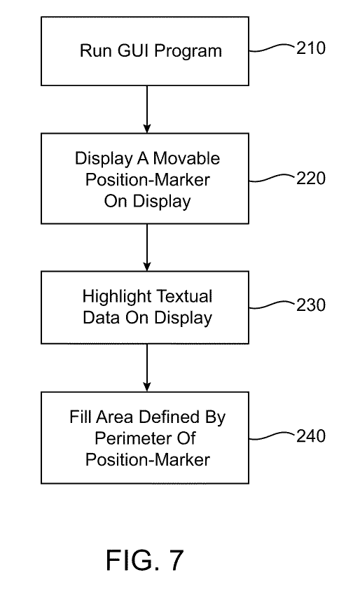

In at least one embodiment as illustrated in FIG. 7, a method for designating an area 160 of interest on a display screen 322 of an electronic device utilizing an at least partially filled movable position-marker 130 is presented. The method involves running a graphical user interface program on a microprocessor of the electronic device (block 210) and displaying a page of information on the display screen 322 (block 220). The method also designates a partial area of the page of information representing a portion of the displayed information with an overlaid position-marker 130 having a perimeter 170 defining a highlighting area (block 230) that is at least partially non-uniformly filled (block 240). A substantial entirety of the highlighting are can be non-uniformly filled. As described above, the highlighting area 160 can be filled utilizing an image file. The designated portion or highlighted area 160 of the displayed information to be edited can be text 150. Likewise, the designated portion of the displayed information can be a selected menu item 125. The non-uniformly filled area 160 can be partially transparent, thus leaving the designated text to be edited visible on the display screen 322, as in FIG. 4.

In at least one embodiment, an electronic device 300 for highlighting an area of a displayed page is presented. The electronic device 300 can include a body housing a display screen 322. Additionally, the electronic device 300 can include a microprocessor 338 in data-communication with the display screen 322. Furthermore, a microprocessor-run graphical user interface software can be programmed to display a page of information on the display screen; and designate a partial area of the page of information representing a portion of the displayed information with an overlaid position-marker having a perimeter defining a highlighting area that is at least partially non-uniformly filled. In other embodiments, additional features as described hereinabove can be included as well.

In yet another embodiment, a computer-readable medium having a computer program for highlighting an area of a displayed page is disclosed. The computer program causes a computer to display a page of information on the display screen. Additionally, the computer program can cause the computer to designate a partial area of the page of information representing a portion of the displayed information with an overlaid position-marker having a perimeter defining a highlighting area that is at least partially non-uniformly filled. In other embodiments, additional features as described hereinabove can be included as well.

In at least one embodiment, this disclosure addresses the code or pseudo-code that would be used to create the above described technical features shown on the graphical user interface. This requires creation of a definition tag or class for use within an object oriented programming language which includes a subclass which will accept color definitions for the four corners of a rectangular area and that uses one or more algorithms to interpolate a unidirectional color intensity gradient between the side formed by one set of corners and the side formed by the other set of corners. It is contemplated that this method could be implemented as part of a larger theme, though this would not be required in order to fall within the scope of the disclosure.

As an example, consider the creation of a definition tag or object named backgrounddef (short for background definition). Those skilled in the art will recognize this as having the common XML style syntax.

<backgrounddef name= “textString”>

<image src= “image.png” type=
“repeat_none/repeat_horizontal/repeat_both/repeat_scale_to_fit”
/>

</backgrounddef>
<backgrounddef name= “textString2”>

<color code= “#000000” opacity= “165”/>

</backgrounddef>
<backgrounddef name= “textString3”>

<gradient

topLeft= “#000000”
topRight= “#000000”
bottomLeft= “#000000”
bottomRight= “#000000” />

</backgrounddef>

The exemplary code provides that an image from a particular source file will be used to draw the background. It will be repeated according to the rules such as ‘repeat none,’ ‘repeat horizontal,’ ‘repeat both’, or ‘scale to fit.’

The exemplary code specifies background color, and can be hexadecimal, HTML or the like. The opacity specifies the level of transparency for the color of the caret, with 0 being complete transparency and 225 being opaque.

The top left color of the gradient, is provided in hexadecimal RGB or as a named color associated with a standard hexadecimal value, for example “white”=“#FFFFFF”. The top right color, bottom left color and bottom right color are also shown in either hexadecimal RGB or as a named color associated with a standard hexadecimal value.

A background can either refer back to a named background, for example, <background name=“textString”/> or include the definition inline <background> <gradient . . . /></background>.

The designation ‘Name=“testString”’ names a particular instance of the background object. The background object must be named in order to instantiate background definition. The background tag specifies a background definition using only the name attribute or the color attribute, but not both. The use of the “exclusive or” ensures compatibility with older themes.

The colors of the four corners are specified with hexadecimal color code in the present example. A subroutine or function will be called which will interpolate colors between these corners so as to define a gradient within the area bounded by the corners.

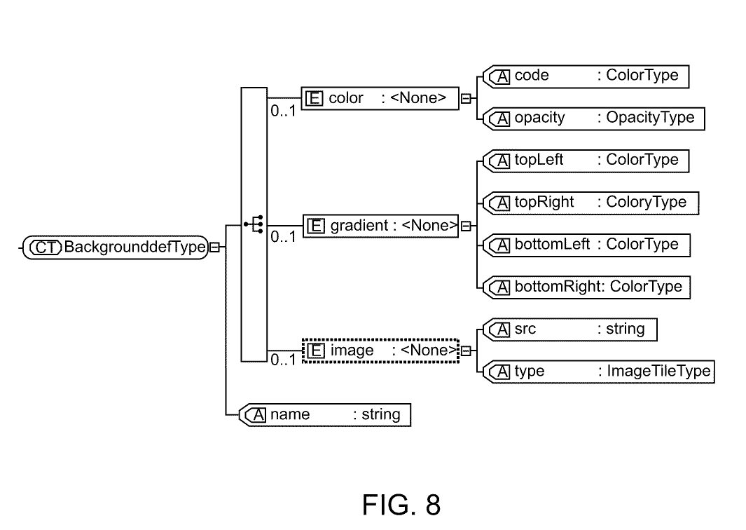

The above pseudo-code can also be illustrated and described in relation to the flow diagram tree shown in FIG. 8. In particular, the discussion is focused on the backgrounddef type. This backgrounddef type defines the highlighting portion as described above. The item name indicates that a string is expected. The name defines how the particular backgrounddef will be called. Three options are presented on the tree. These options are shown for illustrative purposes and other embodiments can be included according to the above disclosure. The item color allows for a definition to include a color type that defines the color to be used. Additionally, the opacity allows the ability to define the transparency or opacity associated with the highlighting area. The gradient allows for defining the color at a top left, top right, bottom left, and bottom right corner of a rectangle to be defined. Once those corners of the rectangle are defined an interpolation routine performs the calculations to determine the gradient of color shown in the highlighting area. While a rectangle has been presented herein, other configurations are considered within the scope of this disclosure. Additionally, an image item is shown and it contains information that allows for a definition of the name of the image along with its file type. In at least one embodiment only one of color, gradient or image can be associated with a given backgrounddef. In other embodiments one or more of the color, gradient, and image can be defined within backgrounddef type.

While the above description generally describes the systems and components associated with a handheld electronic device, the electronic device 300 could be another communication device such as a PDA, a laptop computer, desktop computer, a server, or other communication device. In those embodiments, different components of the above system might be omitted in order provide the desired electronic device 300. Additionally, other components not described above can be required to allow the electronic device 300 to function in a desired fashion. The above description provides only general components and additional components can be required to enable the system to function. These systems and components would be appreciated by those of ordinary skill in the art.

What is claimed is:

1. A method for designating an area of interest on a display screen of a handheld electronic communication device utilizing a movable overlaid position-marker, said method comprising:
displaying a page of information on the display screen; and
designating an area of the page of information representing a portion of the displayed information with the movable overlaid position-marker having a perimeter defining a highlighting area, wherein the highlighting area is non-uniformly filled.

2. The method as recited in claim 1, wherein a substantial entirety of said highlighting area is opaque.

3. The method as recited in claim 2, wherein said substantial entirety of said highlighting area is filled utilizing an image file.

4. The method as recited in claim 3 wherein the image file is one of a bitmap, a portable network graphic, a jpeg, or a graphics interchange format image.

5. The method as recited in claim 2, wherein said perimeter of the highlighting area is polygonal shaped.

6. The method as recited in claim 2, wherein said perimeter of the highlighting area is substantially rectangular shaped.

7. The method as recited in claim 2, wherein said perimeter of the highlighting area is rectangular shaped.

8. The method as recited in claim 7, wherein a substantial entirety of the highlighting area is filled by a color having a darkness gradient increasing from one side of the area toward an opposite side of the rectangular shaped highlighting area.

9. The method as recited in claim 7, wherein the substantial entirety of the highlighting area is filled by a plurality of colors.

10. The method as recited in claim 7, wherein at least two corners of the highlighting area are filled by different colors.

11. The method as recited in claim 7, wherein the designated portion of the displayed information is text to be edited.

12. The method as recited in claim 11, wherein the highlighting area appears at least partially transparent thereby leaving the designated text to be edited visible on the display screen.

13. The method as recited in claim 7, wherein the designated portion of the displayed information is a selected menu item.

14. The method as recited in claim 13, wherein the highlighting area appears at least partially transparent, thereby leaving the selected menu item visible on the display screen.

15. The method recited in claim 1, further comprising adjusting the using data obtained from a layout manager for optionally controlling the display of template information.

16. The method recited in claim 15, further comprising filling a substantial entirety of said highlighting area using an image obtained from the layout manager.

17. The method recited in claim 0, further comprising modifying a selected image associated with the highlighting area using data from the layout manager that includes theme information for displaying images on the graphical user interface.

18. An electronic device for highlighting an area of a displayed page, said device comprising:
a body housing a display screen;
a microprocessor in data-communication with the display screen;
a microprocessor-run graphical user interface software programmed to:
display a page of information on the display screen; and
designate a partial area of the page of information representing a portion of the displayed information with an overlaid position-marker having a perimeter defining a highlighting area that is non-uniformly filled.

19. A computer-readable medium having a computer program for highlighting an area of a displayed page, the computer program causing a computer to:
display a page of information on the display screen; and
designate a partial area of the page of information representing a portion of the displayed information with an overlaid position-marker having a perimeter defining a highlighting area that is non-uniformly filled.
